(19) United States
(12) Patent Application Publication
(10) Pub. No.: US 2006/0126743 A1
(43) Pub. Date: Jun. 15, 2006

(54) Variable length code decoder and decoding method for variable length codes

(75) Inventors: Satoshi Takekawa, Kanagawa (JP); Shuji Michinaka, Kanagawa (JP); Kiwamu Watanabe, Kanagawa (JP); Tatsuhiro Suzumura, Kanagawa (JP); Akihiro Oue, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/127,225

(22) Filed: May 12, 2005

(30) Foreign Application Priority Data
Dec. 10, 2004 (JP) P2004-358398

(51) Int. Cl. H04N 11/04; H04B 1/66; H04N 11/02; H04N 7/12

(52) U.S. Cl. 375/240.23

(57) ABSTRACT

The present invention provides a moving picture format variable length code (VLC) decoder that decodes at a high speed. The VLC decoder includes an input data memory, which is stored with a pixel data coefficient string in moving picture format, a table reference device, which is stored with table reference data and receives memory data from the input data memory, table storage memory including a reference table, which is stored with parametric data, receives table reference data ARG from the table reference device, and transmits parametric data to the table reference device, and output data memory, which receives reference table data made from a coefficient flag output from the table reference device and the last coefficient flag.

### CROSS REFERENCE TO RELATED APPLICATIONS AND INCORPORATION BY REFERENCE

This application is based upon and claims the benefit of priority from prior Japanese Patent Application P2004-358398 filed on Dec. 10, 2004; the entire contents of which are incorporated by reference herein.

### BACKGROUND OF THE INVENTION

1. Field of the Invention

The present invention relates to a variable length code (VLC) decoder for a pixel data coefficient string (bin string) in moving picture format H.264 and a decoding method for the same.

2. Related Background Art

In audio-visual (AV) multimedia systems, advanced video coding (AVC) is referred to as H.264/AVC (see, Sakae Okubo, Shinya Kadono, Yoshihiro Kikuchi, Teruhiko Suzuki, at al. ‘Impress Standard Textbook Series H.264/AVC Textbook’ issued by IMPRESSNET BUSINESS COMPANY, Aug. 11, 2004, p.3-4, 144-157).

H.264/AVC provides a simple table-based transform and highly efficient coding, which is one type of entropy coding (variable length coding) for syntactic elements or information such as discrete cosine transform (DCT) coefficients or motion vectors to be transferred in a predetermined syntax and may be used for encoding DCT coefficients so as to achieve high coding efficiency.

According to that standard, three types of highly efficient coding: variable length coding referred to as context-adaptive variable length coding (CAVLC) and arithmetic coding referred to as context-adaptive binary arithmetic coding (CABAC) as well as basic coding referred to as exponential Golomb coding are available. ‘Context-adaptive’ refers to adaptively selecting a highly efficient coding in conformity with surrounding circumstances. CABAC can be used for only H.264/AVC main profiles; either CAVLC or CABAC is selected based on the value of a flag in a picture parameter set, and the selected coding is then used as a highly efficient entropy coding.

CAVLC is used only for coding DCT coefficients. CAVLC zigzag-scans DCT coefficients, making a one-dimensional vector, and necessary information for decoding, such as coefficients or the lengths of successive ‘0’s (‘run’), are then encoded. H.264/AVC does not encode a combination of ‘run’ and ‘level’ according to Moving Picture Experts Group (MPEG)-2, but separately encodes ‘run’ and ‘level’ in the reverse order using respective variable length coding (VLC) tables. On the other hand, combining ‘run’ and ‘level’ and decoding the resulting data is carried out on the decoding side, thereby providing the resulting decoded coefficients. VLC tables used for decoding ‘run’ and ‘level’ and an outline of decoding the same are disclosed in Non Patent publication (see, Sakae Okubo, Shinya Kadono, Yoshihiro Kikuchi, Teruhiko Suzuki, at al. ‘Impress Standard Textbook Series H.264/AVC Textbook’ issued by IMPRESSNET BUSINESS COMPANY, Aug. 11, 2004, p.3-4, 144-157). When encoding information such as the number of the non-zero coefficients (TotalCoeff) and number of the last successive coefficients of an absolute value of 1 (TrailingOnes) other than ‘run’ and ‘level’, one of multiple VLC tables is adaptively selected in accordance with surrounding macro blocks (MBs) and then encoded. This is one reason for high efficiency encoding of CAVLC.

CABAC has, in addition to a conventional binary arithmetic coding unit, a binarizing unit, which converts a multi-valued signal (e.g., a signal of −3 or +6) to a binary signal (a signal made up of 0 and 1), and a context calculation unit, which calculates and updates the probability that binary signals to be encoded appear, in response to the surrounding circumstances (see, Sakae Okubo, Shinya Kadono, Yoshihiro Kikuchi, Teruhiko Suzuki, at el. ‘Impress Standard Textbook Series H.264/AVC Textbook’ issued by IMPRESSNET BUSINESS COMPANY, Aug. 11, 2004, p.3-4, 144-157).

### SUMMARY OF THE INVENTION

An aspect of the present invention inheres in A variable length code decoder which includes: input data memory configured to be stored with a pixel data coefficient string in a moving picture format; a table reference device configured to store table reference data and receive memory data from the input data memory; a table storage memory configured to comprise a reference table stored with parametric data and receives the table reference data from the table reference device, and transmits the parametric data to the table reference device; and an output data memory configured to receive a coefficient flag to be output from the table reference device and reference table data that comprises the coefficient flag to be output and a corresponding last coefficient flag.

Another aspect of the present invention inheres in a method for decoding a variable length code which includes: initializing variables, data, coefficient flags, and the last coefficient flag to be internally used to ‘0’, and initializing the number of bits m to be used for determination of a pixel data coefficient string from the beginning of the pixel data coefficient string to ‘n’; removing m bits from the pixel data coefficient string and storing the m bits in temporary variable data; obtaining the number of coefficient flags obtainable from the beginning of the pixel data coefficient string, the sum of the number of coefficient flags obtainable from the beginning of the pixel data coefficient string and the number of a corresponding last coefficient flag, and a flag that indicates whether the last coefficient flag is ‘1’ as variables from a reference table using the temporary variable data as an index; calculating coefficient flags, variable data necessary for a loop processing, and the number of bits m from the variables obtained from the reference table; extracting from upper bits of the variable data, the same number of coefficient flags as the outputtable coefficient flags, storing the extracted bits, and processing to-be-shifted bits of data corresponding to the sum of the outputtable coefficient flags and the number of a corresponding last coefficient flag, so as to shift the data to-be-shifted bits to the left and holding lower n bits of the variable data; determining whether the last coefficient flag is ‘1’; extracting m-bit data from the pixel data coefficient string via a loop when the last coefficient flag is ‘0’ and returning to the step of storing temporary variable data; and setting ‘1’ to the last coefficient flag as the coefficient flag obtained in the loop is the last non-zero coefficient when the last coefficient flag is ‘1’.

Another aspect of the present invention inheres in a method for decoding a variable length code which includes: initializing variables, data, coefficient flags, and the last coefficient flag to be internally used to ‘0’ and initializing the number of bits m to be used for determination of a pixel data coefficient string from the beginning of the pixel data coefficient string to ‘n’; extracting m-bit data from the pixel data coefficient string and storing the m bit data in temporary variable data; obtaining the number of outputtable coefficient flags from a reference table, the sum of the number of the outputtable coefficient flags and the number of a corresponding last coefficient flag, a flag that indicates whether the last coefficient flag is ‘1’, and the values of the outputtable coefficient flags using the temporary variable data as an index; calculating coefficient flags, variable data necessary for a loop processing, and the number of bits m from the variables obtained from the reference table; storing values of the same number of respective coefficient flags as the outputtable coefficient flags, and processing to-be-shifted bits of data corresponding to the sum of the number of the outputtable coefficient flags and the number of a corresponding last coefficient flag, so as to shift the data to-be-shifted bits to the left and holding lower n bits of the variable data; determining whether the last coefficient flag is ‘1’; extracting m-bit data from the pixel data coefficient string via a loop when the last coefficient flag is ‘0’ and returning to the step of storing the m bit data in temporary variable data; and setting ‘1’ to the last coefficient flag as the coefficient flag obtained in the loop is the last non-zero coefficient when the last coefficient flag is ‘1’.

### BRIEF DESCRIPTION OF DRAWINGS

FIG. 1A is a schematic diagram regarding coefficient string parameters A, B, C and D explaining a VLC decoding method according to a first embodiment of the present invention;

FIG. 1B is a schematic diagram explaining the VLC decoding method according to the first embodiment of the present invention and also explaining a process flow for the VLC decoding method;

FIG. 1C is a schematic block diagram explaining the VLC decoding method according to the first embodiment of the present invention and showing a pixel data coefficient string;

FIG. 2 is a flowchart for a VLC decoding method for generally considered pixel data coefficient strings;

FIG. 3A is a flowchart explaining the VLC decoding method, according to the first embodiment of the present invention, and particularly explaining a VLC decoding method of determining three bits at a time from a pixel data coefficient string using a reference table;

FIG. 3B is a drawing explaining the VLC decoding method, according to the first embodiment of the present invention, and shows a reference table I to be used for the VLC decoding method for determining three bits at a time from a pixel data coefficient string;

FIG. 4A is a drawing explaining a VLC decoding method, according to a second embodiment of the present invention, and shows an exemplary pseudo-code list to be used for the VLC decoding method for determining four bits at a time from a pixel data coefficient string using a reference table;

FIG. 4B is a drawing explaining the VLC decoding method, according to the second embodiment of the present invention, and shows a reference table I to be used for the VLC decoding method for determining four bits at a time from a pixel data coefficient string;

FIG. 5A is a drawing explaining a VLC decoding method, according to a third embodiment of the present invention, and shows a flowchart for the VLC decoding method for determining four bits at a time from a pixel, data coefficient string using a reference table;

FIG. 5B is a drawing explaining the VLC decoding method, according to the third embodiment of the present invention, and shows a reference table I to be used for the VLC decoding method for determining four bits at a time from a pixel data coefficient string;

FIG. 6 is a schematic diagram showing an entire structure of a VLC decoder, according to a fourth embodiment of the present invention, which uses a VLC decoding method for a pixel data coefficient string in moving picture format H.264;

FIG. 7 is a schematic diagram showing an entire structure of a VLC decoder, according to the fourth embodiment of the present invention, which uses a VLC decoding method for a pixel data coefficient string in moving picture format H.264;

FIG. 8 is a schematic diagram showing a detailed structure of a VLC decoder, according to a fifth embodiment of the present invention, which uses a VLC decoding method for a pixel data coefficient string in moving picture format H.264; and

FIG. 9 is a schematic diagram showing a detailed structure of a VLC decoder, according to a sixth embodiment of the present invention, which uses a VLC decoding method for a pixel data coefficient string in moving picture format H.264;

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

Referring to the drawings, embodiments of the present invention are described below. The same or similar reference numerals are attached to identical or similar parts among the following drawings. The embodiments shown below exemplify an apparatus and a method that are used to implement the technical ideas according to the present invention, and do not limit the technical ideas according to the present invention to those that appear below. These technical ideas, according to the present invention, may receive a variety of modifications that fall within the claims.

Embodiments according to the present invention are explained forthwith while referencing drawings. The same or similar symbols are applied to the same or similar parts throughout the appended drawings. Note that since the drawings are schematically drawn, measurements such as the size of each block, the scale of each reference table and the length of a pixel data coefficient string may be different from reality. Accordingly, the same parts with different dimensions or proportion may be naturally included among drawings.

Moreover, the following embodiments are provided to exemplify apparatus and methods that embody technical ideas of the present invention, and those technical ideas are not limited to the structural arrangement of the parts constituting each block. A variety of modifications to those technical ideas can be made within the scope of the present invention.

A faster processing VLC decoder and a faster decoding method can be provided as compared to processing on a bit-by-bit basis, by a decoding unit of a LVC decoder used for decoding flags, each indicating whether there is a non-zero coefficient in a pixel data coefficient string in picture format H.264, and the last non-zero coefficient flag. The maximum processing speed can be N times greater by determining multiple bits (N bits) at a time from a pixel data coefficient string.

A faster processing VLC decoder and a faster processing decoding method for specific patterns of pixel data coefficient strings can be provided by a decoding unit of a VLC decoder used for decoding flags, each indicating whether there is a non-zero coefficient in a pixel data coefficient string in picture format H.264, and the last non-zero coefficient flag. In the case of determining four bits, for example, at a time from a pixel data coefficient string, if a pixel data coefficient string to be determined is a binary value of ‘1010’, the number of bits from the pixel data coefficient string to be read next in the subsequent step becomes four as compared to the case of two bits, allowing processing of many bits from the pixel data coefficient string in only a single determination step.

In the following descriptions, ‘significant_coeff_flag’ is referred to as ‘coefficient flag’, and ‘last_significant_coeff_flag’ is referred to as ‘last coefficient flag’.

The VLC decoder and the decoding method according to embodiments of the present invention may be used for decoding coefficient flags and the last coefficient flags as parameters in CABAC-decoded data.

A faster processing VLC decoder and a faster decoding method according to the embodiments of the present invention, which are attained by using a reference table including specific parameters, are provided in a processing by a decoding unit of a LVC decoder used for decoding flags, each indicating whether there is a non-zero coefficient in a pixel data coefficient string in picture format H.264, and the last non-zero coefficient flag.

According to the VLC decoder and the decoding method according to the embodiments of the present invention, faster processing by a decoding unit of a LVC decoder used for decoding flags, each indicating whether there is a non-zero coefficient in a pixel data coefficient string in picture format H.264, and the last non-zero coefficient flag can be provided by using a reference table including specific parameters.

### First Embodiment

(VLC Decoding Method)

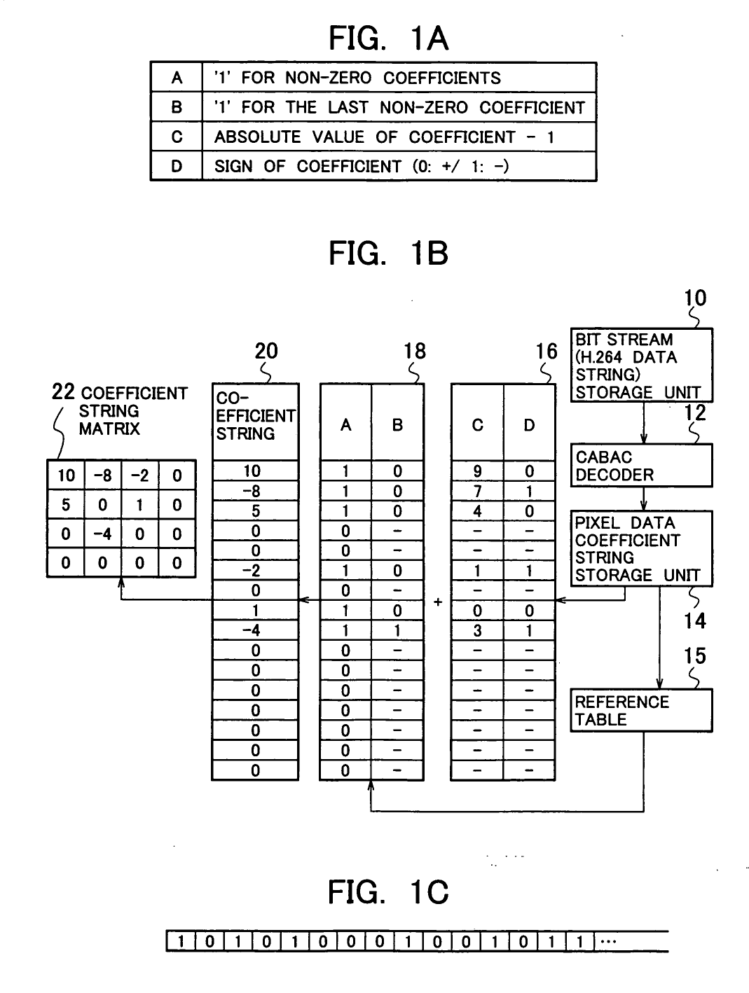

A VLC decoding method according to a first embodiment of the present invention is characterized by a reference table 15 used for VLC decoding parametric data (coefficient flag A) that indicates whether a CABAC decoded pixel data coefficient string is a non-zero coefficient and parametric data (last coefficient flag B) that indicates whether the CABAC decoded pixel data coefficient string is the last non-zero coefficient, as shown in FIG. 1, thereby allowing faster processing.

FIG. 1A shows a definition of coefficient string parameters A, B, C, and D; wherein A denotes that a value of ‘1’ is displayed for a non-zero coefficient. B denotes that a value of ‘1’ is displayed for the last non-zero coefficient. C denotes that the resulting value of the absolute value of a coefficient minus 1 is displayed. D denotes that ‘0’ is displayed for the plus sign of a coefficient, whereas ‘1’ is displayed for the minus sign thereof. FIG. 1B is a schematic diagram explaining a decoding process flow for a VLC decoding method while FIG. 1C schematically shows a pixel data coefficient string.

As shown in FIG. 1B, an H.264 data string stored in a bit-stream (H.264 data string) storage unit 10 is decoded by a CABAC decoder 12. The resulting value is then stored in a pixel data coefficient string storage unit 14.

When taking H.264 coefficient data out of the H.264 data string stored in the bit-stream storage unit 10 and then decoding it into pixel data, a bit stream (H.264 data string) is CABAC-decoded into a pixel data coefficient string as shown in FIG. 1C by the CABAC decoder 12, and then stored in the pixel data coefficient string storage unit 14.

Parametric data indicating whether the CABAC-decoded pixel data coefficient string includes a non-zero coefficient (coefficient flag A) and parametric data indicating where the last non-zero coefficient is located (last coefficient flag B) are generated via the reference table 15 connected to the pixel data coefficient string storage unit 14.

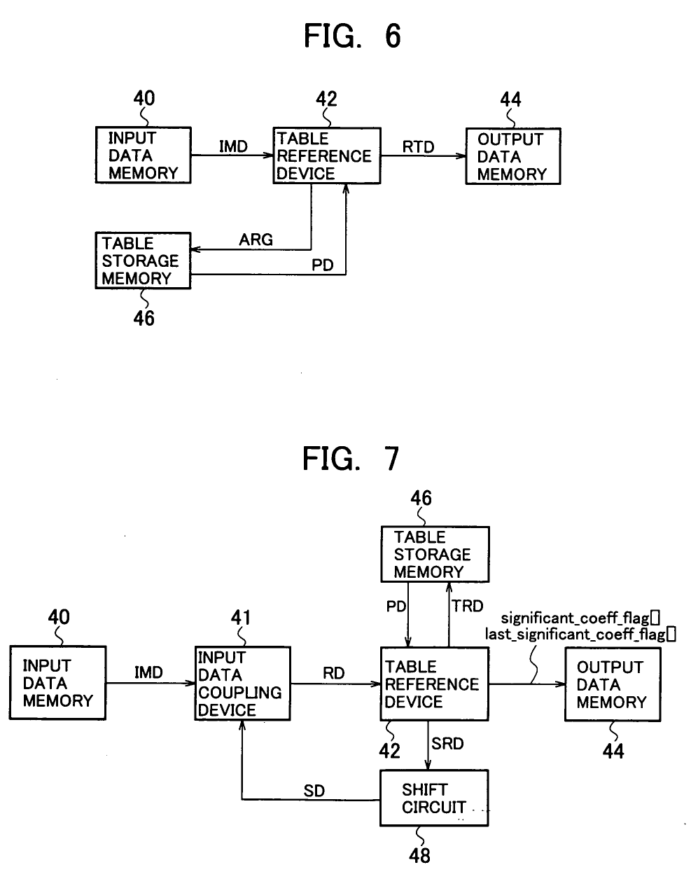

Data in rows A and B (18) are generated from the CABAC-decoded pixel data coefficient string shown in FIG. 1C via the reference table 15. When decoding pixel data, separately generated rows C and D (16) and the rows A and B (18) generated via the reference table 15 are synthesized into a coefficient string 20, thereby providing a coefficient string matrix 22 as shown in FIG. 1B. Note that the VLC decoder is detailed later in the description of a VLC decoder according to a fourth to a sixth embodiment of the present invention with reference to FIGS. 6 to 9.

(Decoding Method for a Pixel Data Coefficient String)

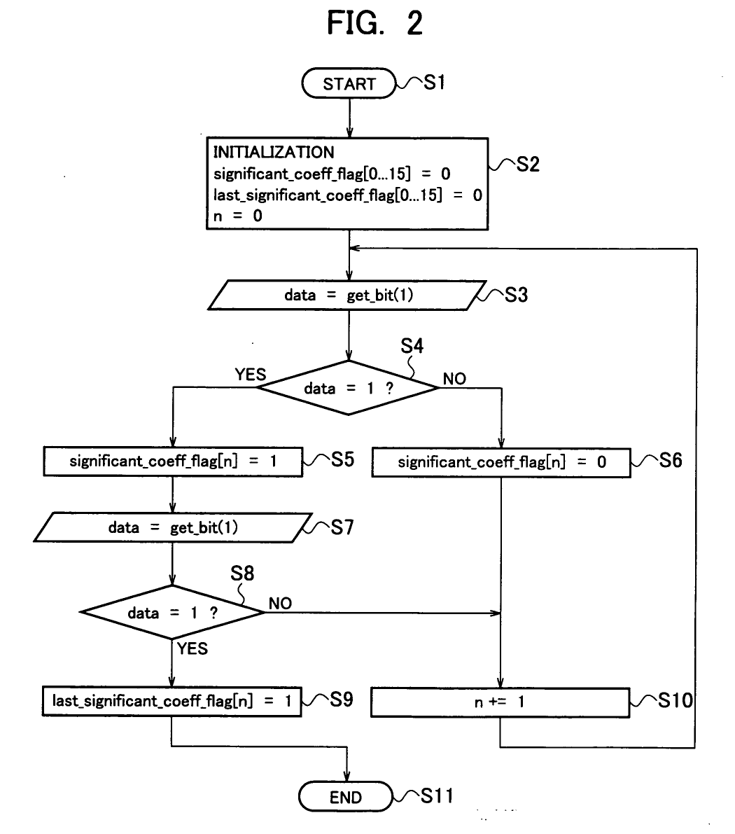

A VLC decoding method used for VLC-decoding a pixel data coefficient string is explained forthwith while referencing to a flowchart shown in FIG. 2.

Processing starts in step S1;

To begin with, the internal state is initialized in step S2. More specifically, significant_coeff_flag [0 . . . 15]=0, last_significant_coeff_flag [0 . . . 15]=0, n=0;

In step S3, 1-bit data is read in from a pixel data coefficient string;

In step S4, whether the read-in 1-bit data is ‘1’ is determined.

If the read-in 1-bit data is ‘0’, significant_coeff_flag [n]=0 in step S6;

In step S10, n is incremented, and then processing returns to step S3. At this time, last_significant_coeff_flag [n]=0.

On the other hand, if the data is ‘1’ in step S4, significant_coeff_flag [n]=1 in step S5, and processing then proceeds to the step of determining the last coefficient flag.

In step S7, 1-bit data is taken from the pixel data coefficient string.

In step S8, whether the 1-bit data taken from the pixel data coefficient string is ‘1’ is determined.

If the data is ‘1’ in step S8, then last_significant_coeff_flag [n]=1 in step S9.

In step S11, processing is concluded.

If the data is ‘0’ in step S8, n is then incremented in step S10, and processing returns to step S3.

As is apparent from these steps, when using a VLC decoding method of VLC-decoding of a generally considered pixel data coefficient string, the same number of steps as the number of bits constituting coefficient flags in a pixel data coefficient string and the last coefficient flag are needed.

The VLC decoder and the decoding method according to the first embodiment of the present invention are used for VLC-decoding parameters such as significant_coeff_flag [ ] and last_significant_coeff_flag [ ] in the data in H.264 picture format decoded by the CABAC decoder 12. A VLC decoding method is explained in detail forthwith.

(VLC Decoding Method for Determining Three-Bits at a Time from a Pixel Data Coefficient String)

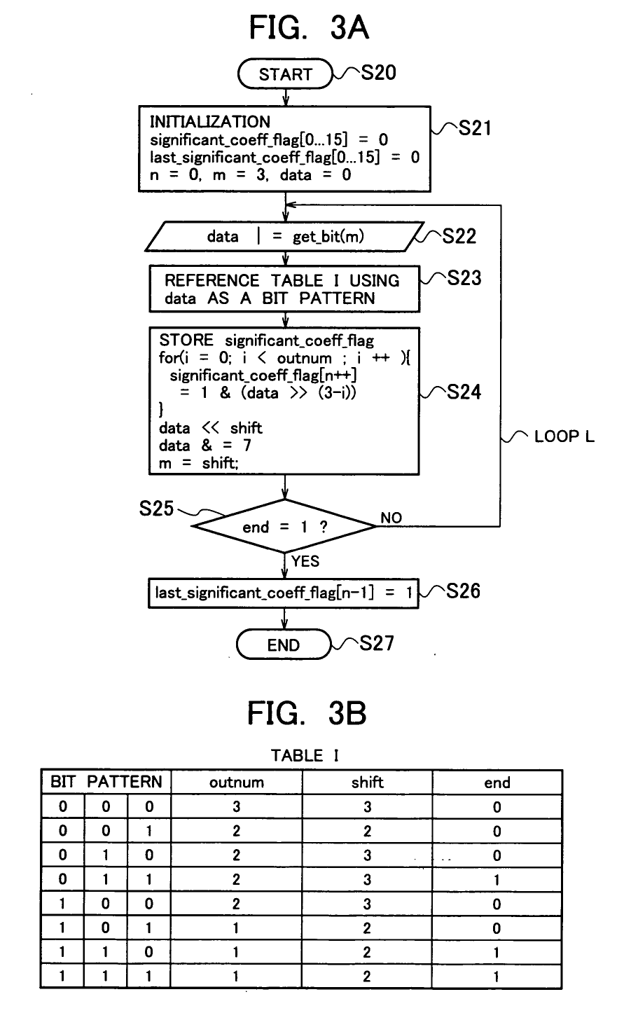

A VLC decoding method for determining three bits at a time from a pixel data coefficient string using a reference table is shown in a flowchart of FIG. 3A and uses reference table I of FIG. 3B.

The VLC decoding method using the reference table I is explained below and provides the number of coefficient flags obtainable from the beginning of the pixel data coefficient string, the sum of the number of coefficient flags obtainable from the beginning of the pixel data coefficient string and the number of a corresponding last coefficient flag, and a flag indicating whether the last coefficient flag is ‘1’ using multiple (N) bits from the pixel data coefficient string as an index.

FIG. 3A is a flowchart for finding an array of significant_coeff_flag [16] stored with flags, each indicating whether each pixel data is a non-zero coefficient, and finding an array of last_significant_coeff_flag [16] stored with flags, each indicating whether the each pixel data is the last non-zero coefficient, by using a pixel data coefficient string as an input. Determination of data is carried out in units of three bits, and the reference table I as shown in FIG. 3B is prepared as a reference table.

Processing starts in step S20;

In step S21, variables n and d a t a to be internally used, and significant_coeff_flag [ ] and last_significant_coeff_flag [ ] to be stored with results are initialized to ‘0’. m denotes the number of bits from the beginning of a pixel data coefficient string to be used for determination; wherein it is initialized to ‘3’.

In step S22, m bits of data are taken from the pixel data coefficient string and then ORed with the present value of the temporary variable data and stored in this variable.

In step S23, outnum (the number of coefficient flags obtainable from the beginning of a pixel data coefficient string), shift (the sum of the number of coefficient flags obtainable from the beginning of the pixel data coefficient string and number of a corresponding last coefficient flag), end (a flag indicating whether the last coefficient flag is ‘1’) are obtained as variables from the reference table I using that data as an index.

In step S24, significant_coeff_flag [ ] and variables: data and m, which are necessary in the subsequent step to loop L, are calculated from the variables obtained from the reference table I.

outnum denotes the number of the coefficient flags obtainable from the beginning of the pixel data coefficient string, and corresponds to outnum bits from the beginning of data in FIG. 3B. Accordingly, the outnum coefficient flags are extracted from the upper bits of data and stored by executing a command statement for (i =0 . . . ) in step S24.

As a result, since data has been processed for the value of shift, which indicates the sum of the number of coefficient flags obtainable from the beginning of the pixel data coefficient string and number of a corresponding last coefficient flag, data is shifted the value of shift to the left, and the lower three bits are held. mdenotes the number of bits to be read in next from the pixel data coefficient string in loop L.

In step S25, it is determined whether the last coefficient flag end is ‘1’.

If the last coefficient flag end is ‘0’ in step S25, processing returns to step S22 via loop L.

If the last coefficient flag end is ‘1’ in step S25, processing proceeds to step S26.

In step S26, since the coefficient flag obtained within the loop L is the last non-zero coefficient, ‘1’ is set to last_significant_coeff_flag [n-1].

In step S27, processing is concluded.

According to the VLC decoding method of the first embodiment of the present invention, VLC-decoding is possible by determining a maximum of three bits at a time from a pixel data coefficient string using the reference table I.

### Second Embodiment

(VLC Decoding Method for Determining Four-Bits at a Time from a Pixel Data Coefficient String)

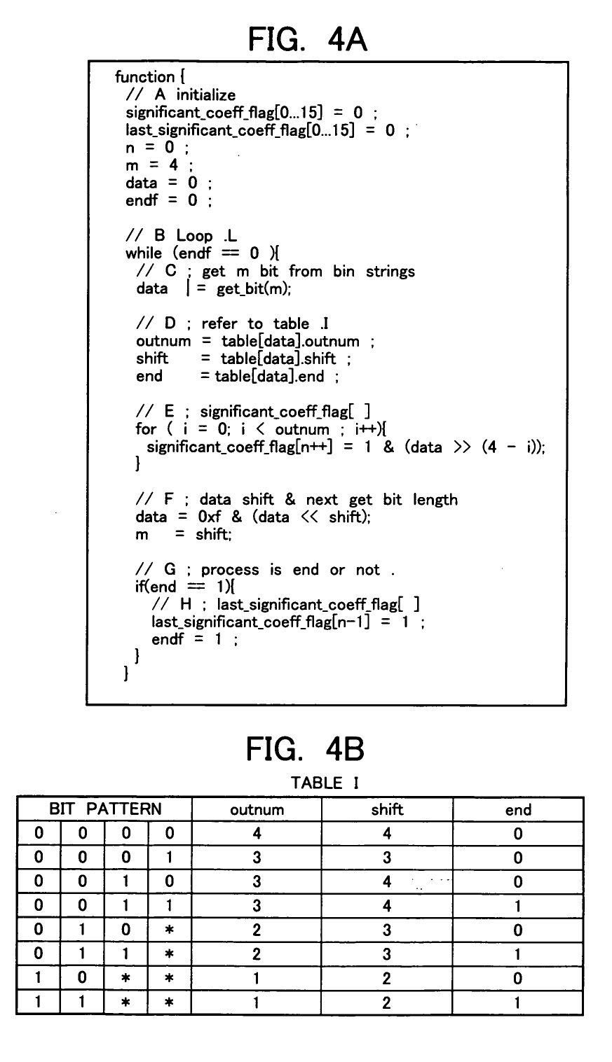

A VLC decoding method according to a second embodiment of the present invention is explained forthwith using a reference table that uses an exemplary pseudo-code list as shown in FIG. 4A and a reference table I shown in FIG. 4B.

A case of VLC-decoding is explained below which provides the number of the coefficient string flags obtainable from the beginning of the pixel data coefficient string, the sum of the number of coefficient string flags obtainable from the beginning of the pixel data coefficient string and the number of a corresponding last coefficient string flag, and a flag indicating whether the last coefficient flag is ‘1’ using multiple (N) bits from the pixel data coefficient string as an index. In reference table I, denotes ‘0’ or ‘1’.

To begin with, variables to be used are initialized in pseudo-code A. Outputs are significant_coeff_flag [0 . . . 15] and last_significant_coeff_flag [0 . . . 15]; wherein data indicating whether a decoded pixel data is non-zero (e.g., ‘1’ for non-zero while ‘0’ for others) is stored in significant_coeff flag [0 . . . 15], and last_significant_coeff_flag [0 . . . 15] is stored with ‘1’ for the last non-zero coefficient and ‘0’ for the others.

Next, in pseudo-code B, VLC-decoding is carried out in loop L while the end flag endf is ‘0’. Function get_bit (m) loads m-bit data as an input, which is then ORed with variable data, and the resulting data is used as an index for the reference table I.

Next, in pseudo-code C, function get_bit (m) extracts the beginning m bits from the pixel data coefficient string, which is an input bit stream.

In pseudo-code D, the reference table I is referenced using data as an index, providing parameters outnum, shift, and end.

outnum denotes the number of the coefficient flags outputtable from the beginning of the pixel data coefficient string, and corresponds to the value of outnum bits from the beginning of data in FIG. 4B.

Afterwards, a command statement for(i=0 . . . ) in pseudo-code E extracts outnum-coefficient string flags from data, and stores the resulting flags shift in FIG. 4B indicates the size of data, which is not used for processing and is left intact for the subsequent step shift corresponds to the number of coefficient string flags outputtable from the beginning of the pixel data coefficient string and number of a corresponding last coefficient string flag.

data in pseudo-code F is shifted shift bits to the left, and the lower four bits are held. m denotes the number of the bits to be read in from the pixel data coefficient string in loop L.

Next, if in pseudo-codes G and H, end provided from the reference table I is ‘1’, a lastly obtained coefficient string flag becomes the last non-zero coefficient. Accordingly, ‘1’ is set to significant_coeff_flag [n-1]. Consequently, leaving loop L, concludes processing.

According to the VLC decoding method, of the second embodiment of the present invention, VLC-decoding is possible by determining a maximum of four bits at a time from the pixel data coefficient string using the reference table I.

### Third Embodiment

(VLC Decoding Method for Determining Four-Bits at a Time from a Pixel Data Coefficient String)

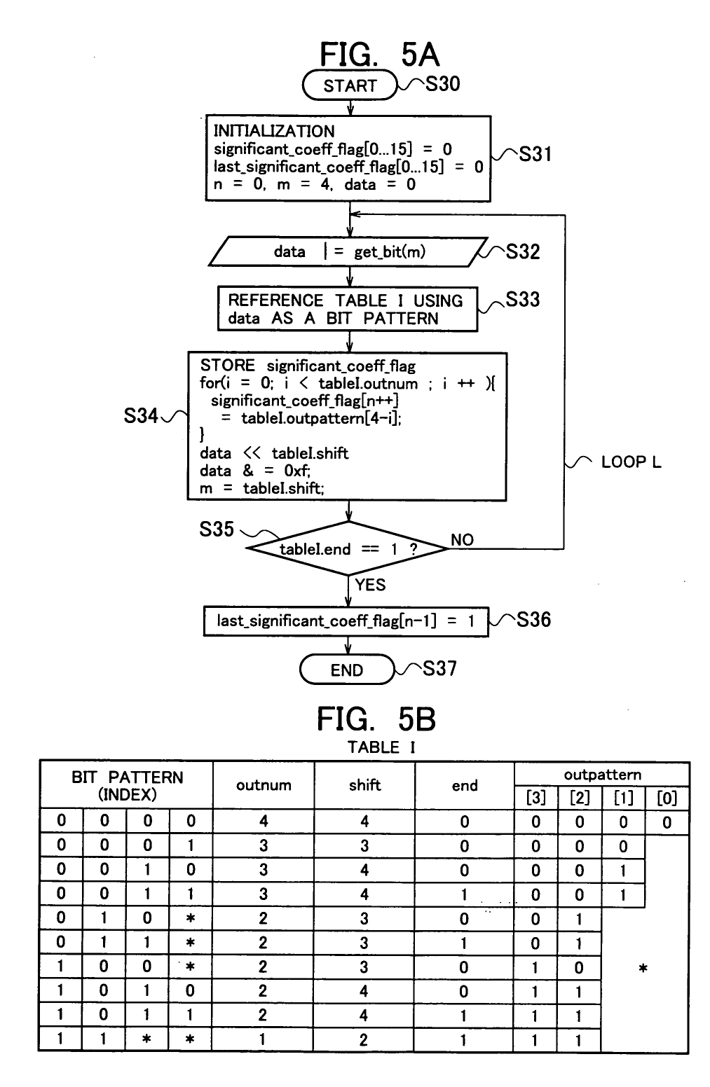

A VLC decoding method according to a third embodiment of the present invention using a reference table is shown in a flowchart of FIG. 5A and uses a reference table I shown in FIG. 5B.

VLC-decoding of a pixel data coefficient string by determining four bits at a time from a pixel data coefficient string, using the reference table I, is shown in FIG. 5. This decoding provides the number of coefficient flags to be output, flag values themselves to be output, the sum of the number of coefficient flags to be output and the number of a corresponding last coefficient flag, and a flag indicating whether the last coefficient flag is ‘1’ by using multiple (N) bits from the pixel data coefficient string as an index.

FIG. 5A shows an exemplary flowchart while FIG. 5B shows the reference table I. * In reference table 1, denotes ‘0’ or ‘1’.

FIGS. 5A and B show how to calculate an array of significant_coeff_flag [16] stored with flags using a pixel data coefficient string as an input. Each of the flags indicates whether pixel data is a non-zero coefficient, and indicates an array of last_significant_coeff_flag [16], which are stored with flags, each indicating whether it is the last non-zero coefficient. Determination of data is carried out in units of four bits, and the reference table I is prepared as a necessary reference table.

In step S30, processing starts.

In step S31, variables n and data to be internally used and significant-coeff_flag [0 . . . 15] and last_significant_coeff_flag [0 . . . 15] to be stored with processing results are initialized to ‘0’. m denotes the number of the bits from the beginning of a pixel data coefficient string to be used for determination; wherein it is initialized to ‘4’ in this embodiment.

In step S32, m bits of data are taken from the pixel data coefficient string, and then ORed with the present value of temporal variable data and stored in the same variable.

In step S33, outnum (the number of outputtable coefficients), shift (the sum of the number of outputtable coefficient flags and number of a corresponding last coefficient flag), end (a flag indicating whether the last coefficient flag is ‘1’), and outpattern (an outputtable coefficient flag value) are obtained from the reference table I of FIG. 5B using data as an index.

In step S34, significant_coeff_flag [ ] and variables data and m, which are necessary in the subsequent step to loop L, are calculated from the variables obtained from the reference table I. outnum and outpattern denote the number of outputtable coefficient flags and the value thereof, respectively; a command statement for (i=0 . . . ) in step S34 stores values incorresponding outnum coefficient flags. As a result, since shift bits from data have been processed, where shift indicates the sum of the number of the outputtable coefficient flags and number of a corresponding last coefficient flag, data is shifted shift bits to the left, and the lower three bits are held. m denotes the number of the bits to be read in next from the pixel data coefficient string in loop L.

In step S35, it is determined whether the last coefficient flag end is ‘1’.

If the last coefficient flag end is ‘0’ in step S35, processing returns to step S32 via loop L.

In step S35, if the last coefficient flag end is ‘1’, processing proceeds to step S36.

In step S36, since the coefficient flag obtained within the loop L is the last non-zero coefficient, ‘1’ is set to last_significant_coeff_flag [n-1].

In step S37, processing is concluded.

According to the VLC decoding method, of the third embodiment of the present invention, VLC-decoding is possible by determining a maximum of four bits at a time from the pixel data coefficient string using a reference table.

### Fourth Embodiment

(VLC Decoder)

FIG. 6 shows an entire schematic structure of a VLC decoder using VLC-decoding of a pixel data coefficient string in picture format H.264, which comprises input data memory 40, a table reference device 42 connected to the input data memory 40 and receives memory data IMD from the input data memory 40, a table storage memory 46 connected to the table reference device 42, receives an argument ARG from the table reference device 42, and then transmits parametric data PD to the table reference device 42, and output data memory 44.connected to the table reference device 42 and receives reference table data RTD.

FIG. 7 shows an entire schematic structure of a VLC decoder using VLC-decoding of a pixel data coefficient string in picture format H.264, which comprises input data memory 40, an input data coupling device 41 connected to the input data memory 40 and receives a memory data signal IMD from the input data memory 40, a table reference device 42 connected to the input data coupling device 41 and receives reference data RD from the input data coupling device 41, table storage memory 46 connected to the table reference device 42, receives table reference data TRD from the table reference device 42, and then transmits parametric data PD to the table reference device 42, output data memory 44 connected to the table reference device 42 and receives from the table reference device 42 significant_coeff_flag [ ] and last_significant_coeff_flag [ ], which represent reference table data RTD, and a first shift circuit 48 connected to the table reference device 42 and receives reference data SRD from the table reference device 42. The input data coupling device 41 couples shift data SD received from the first shift circuit 48 and the memory data signal IMD received from the input data memory 40. In FIG. 7, the table reference data TRD to be transmitted from the table reference device 42 to the table storage memory 46 corresponds to the argument ARG in FIG. 6. In actual design, a method of referencing the reference table I using the table reference data TRG itself as the argument ARG may be utilized.

According to the VLC decoder of the fourth embodiment of the present invention, VLC-decoding is possible by determining multiple bits at a time from a pixel data coefficient string using a reference table and utilizing the VLC-decoding methods according to the above-described first to the third embodiment.

### Fifth Embodiment

(VLC Decoder)

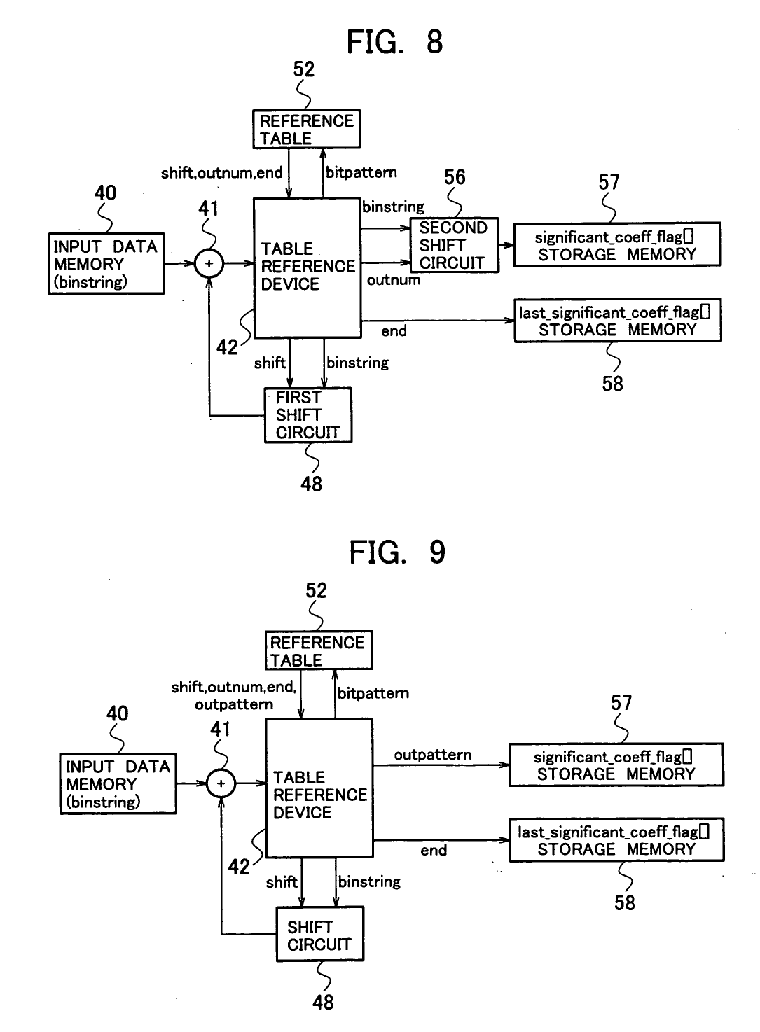

FIG. 8 shows a VLC decoder according to a fifth embodiment of the present invention, which comprises input data memory 40 stored with a pixel data coefficient string (binstring), an input data coupling device 41 connected to the input data memory 40, a table reference device 42 connected to the input data coupling device 41, a reference table 52 connected to the table reference device 42, receives a bit pattern (bitpattern) from the table reference device 42, which represents the table reference data TRD, and transmits to the table reference device 42 shift (the sum of the number of outputtable coefficient flags and the number of a corresponding last coefficient flag), outnum (the number of outputtable coefficient flags), and end (a flag indicating whether the last coefficient flag is ‘1’), a second shift circuit 56 connected to the table reference device 42 and receives a pixel data coefficient string (binstring) and outnum from the table reference device 42, significant_coeff_flag [ ] storage memory 57 connected to the second shift circuit 56 and is stored with significant_coeff_flag [ ], last_significant_coeff_flag [ ] storage memory 57 connected to the table reference device 42, receives end from the table reference device 42, and is stored with the last_significant_coeff_flag [ ], and a first shift circuit 48 connected to the table reference device 42, receives binstring and shift from the table reference device 42, and transmits shift data SD to the input data coupling device 41.

According to the VLC decoder of the fifth embodiment of the present invention, VLC-decoding is possible by determining multiple bits at a time from a pixel data coefficient string using a reference table and utilizing the VLC-decoding methods according to the above-described first and the second embodiment.

### Sixth Embodiment

(VLC Decoder) FIG. 9 shows a VLC decoder according to a sixth embodiment of the present invention, which comprises input data memory 40 storing a pixel data coefficient string (binstring), an input data coupling device 41 connected to the input data memory 40, a table reference device 42 connected to the input data coupling device 41, a reference table 52 connected to the table reference device 42 to receive bitpattern from the table reference device 42, and transmits to the table reference device 42 shift, outnum, end, and outpattern (the value of an outputtable coefficient flag), significant_coeff_flag [ ] storage memory 57 connected to the table reference device 42, receives outpattern from the table reference device 42, and stores significant_coeff_flag [ ], last_significant_coeff_flag[ ] storage memory 57 connected to the table reference device 42, receives end from the table reference device 42, and stores last_significant_coeff_flag [ ], and a first shift circuit 48 connected to the table reference device 42 and receives binstring and shift from the table reference device 42, and transmits shift data SD to the input data coupling device 41.

According to the VLC decoder of the sixth embodiment of the present invention, VLC-decoding is possible by determining multiple bits, at a time, from a pixel data coefficient string using a reference table and utilizing the VLC-decoding method according to the above-described third embodiment.

### Other Embodiments

As described above, the present invention has been disclosed according to embodiments; however, the descriptions and drawings constituting a part of this disclosure should not be understood to limit the scope of the present invention. This disclosure allows those skilled in the art to understand a variety of substitutions, embodiments, and operational technologies.

The descriptions of the first to the third embodiment of the present invention describe VLC-decoding by determining three bits or four bits at a time from a pixel data coefficient string using a reference table; however, it is apparent that VLC-decoding is possible by determining N bits at a time from a pixel data coefficient string (N>4) in the same manner.

Accordingly, the present invention includes a variety of embodiments or the like not described herein. Therefore, the technical scope of the present invention is determined only by specified features of the invention according to the following claims that can be regarded appropriately from the above descriptions.

As described above, the present invention has been disclosed according to the first to the sixth embodiments; however, the descriptions and drawings constituting a part of this disclosure should not be understood to limit the scope of the present invention. This disclosure allows those skilled in the art to understand a variety of substitutions, embodiments, and operational technologies.

Accordingly, the present invention includes a variety of embodiments or the like not described herein. Therefore, the technical scope of the present invention should be limited by only inventive specific items clearly described above according to the following claims.

While the present invention is described in accordance with the aforementioned embodiments, it should not be understood that the description and drawings that configure part of this disclosure are to limit the present invention. This disclosure makes clear a variety of alternative embodiments, working examples, and operational techniques for those skilled in the art.

Accordingly, the technical scope of the present invention is defined by only the claims that appear appropriate from the above explanation.

Various modifications will become possible for those skilled in the art after receiving the teachings of the present disclosure without departing from the scope thereof.

What is claimed is:

1. A variable length code decoder comprising:
input data memory configured to be stored with a pixel data coefficient string in a moving picture format;
a table reference device configured to store table reference data and receive memory data from the input data memory;
a table storage memory configured to comprise a reference table stored with parametric data and receives the table reference data from the table reference device, and transmits the parametric data to the table reference device; and
an output data memory configured to receive a coefficient flag to be output from the table reference device and reference table data that comprises the coefficient flag to be output and a corresponding last coefficient flag.

2. The variable length code decoder of claim 1, wherein the reference table further comprises:
a number of coefficient flags obtainable from the beginning of the pixel data coefficient string using multiple bits from a pixel data coefficient string as an index;
the sum of the number of coefficient flags obtainable from the beginning of the pixel data coefficient string and a number of a corresponding last coefficient flag; and
a flag indicating whether the last coefficient flag is ‘1’.

3. The variable length code decoder of claim 1, wherein a reference table further comprises:
the number of coefficient flags to be output using multiple bits from a pixel data coefficient string as an index;
values of the-coefficient flags to be output;
the sum of the number of coefficient flags to be output and a number of a corresponding last coefficient flag; and
a flag indicating that the last coefficient flag is ‘1’.

4. The variable length code decoder of claim 1 further comprising:
an input data coupling device connected between the input data memory and the table reference device, and receives a memory data signal from the input data memory, and transmits reference data to the table reference device; and
a first shift circuit connected to the table reference device, and receives reference data from the table reference device, and transmits shift data to the input data coupling device.

5. The variable length code decoder of claim 4, wherein the output data memory receives a coefficient flag and the last coefficient flag, which are reference table data, from the table reference device.

6. The variable length code decoder of claim 4, wherein the input data coupling device couples shift data received from the shift circuit and a memory data signal received from the input data memory.

7. The variable length code decoder of claim 4, wherein the table reference data to be transmitted from the table reference device to the table storage memory is an argument.

8. The variable length code decoder of claim 4, wherein the reference table further comprises:
the number of coefficient flags obtainable from the beginning of the pixel data coefficient string using multiple bits from a pixel data coefficient string as an index;
the sum of the number of coefficient flags obtainable from the beginning of the pixel data coefficient string and the number of a corresponding last coefficient flag; and
a flag that indicates whether the last coefficient flag is ‘1’.

9. The variable length code decoder of claim 4, wherein the reference table further comprises:
the number of coefficient flags to be output using multiple bits from a pixel data coefficient string as an index;
the values of the coefficient flags to be output;
the sum of the number of coefficient flags to be output and the number of a corresponding last coefficient flag; and
a flag that indicates whether the last coefficient flag is ‘1’.

10. The variable length code decoder of claim 1 further comprising:
an input data coupling device connected to the input data memory to receive a memory data signal from the input data memory, and to transmit reference data to the table reference device;
a first shift circuit connected to the table reference device to receive the pixel data coefficient string and the sum of the number of outputtable coefficient flags and a number of a corresponding last coefficient flag from the table reference device, and to transmit shift data to the input data coupling device;
a second shift circuit connected to the table reference device which receives the pixel data coefficient string and the number of outputtable coefficient flags from the table reference device;
a coefficient flag storage memory connected to the second shift circuit to stored coefficient flags; and
a last coefficient flag storage memory connected to the table reference device to receive a last coefficient flag from the table reference device, and stores the last coefficient flag.

11. The variable length code decoder of claim 10, wherein the reference table further comprises:
the number of coefficient flags obtainable from the beginning of the pixel data coefficient string using multiple bits from a pixel data coefficient string as an index;
the sum of the number of coefficient flags obtainable from the beginning of the pixel data coefficient string and the number of a corresponding last coefficient flag; and
a flag that indicates whether the last coefficient flag is ‘1’.

12. The variable length code decoder of claim 10, wherein the input data coupling device couples shift data received from the first shift circuit and a memory data signal received from the input data memory.

13. The variable length code decoder of claim 1 further comprising:
an input data coupling device connected to the input data memory to receive a memory data signal from the input data memory, and to transmit reference data to the table reference device;
a first shift circuit connected to the table reference device to receive the pixel data coefficient string, the sum of the number of outputtable coefficient flags and a number of a corresponding last coefficient flag from the table reference device, and to transmit shift data to the input data coupling device;
a coefficient flag storage memory connected to the table reference device to receive the values of the outputtable coefficient flags from the table reference device, and stores the coefficient flags; and
a last coefficient flag storage memory connected to the table reference device to receive a last coefficient flag from the table reference device, and stores the last coefficient flag.

14. The variable length code decoder of claim 13, wherein the reference table further comprises:
the number of coefficient flags to be output using multiple bits from a pixel data coefficient string as an index;
the values of the coefficient flags to be output; the sum of the number of the coefficient flags to be output and the number of a corresponding last coefficient flag; and
a flag that indicates whether the last coefficient flag is ‘1’.

15. The variable length code decoder of claim 14, wherein the input data coupling device couples shift data received from the first shift circuit and a memory data signal received from the input data memory.

16. A method for decoding a variable length code comprising:
initializing variables, data, coefficient flags, and the last coefficient flag to be internally used to ‘0’, and initializing the number of bits m to be used for determination of a pixel data coefficient string from the beginning of the pixel data coefficient string to ‘n’;
removing m bits from the pixel data coefficient string and storing the m bits in temporary variable data;
obtaining the number of coefficient flags obtainable from the beginning of the pixel data coefficient string, the sum of the number of coefficient flags obtainable from the beginning of the pixel data coefficient string and the number of a corresponding last coefficient flag, and a flag that indicates whether the last coefficient flag is ‘1’ as variables from a reference table using the temporary variable data as an index;
calculating coefficient flags, variable data necessary for a loop processing, and the number of bits m from the variables obtained from the reference table;
extracting from upper bits of the variable data, the same number of coefficient flags as the outputtable coefficient flags, storing the extracted bits, and processing to-be-shifted bits of data corresponding to the sum of the outputtable coefficient flags and the number of a corresponding last coefficient flag, so as to shift the data to-be-shifted bits to the left and holding lower n bits of the variable data;
determining whether the last coefficient flag is ‘1’; extracting m-bit data from the pixel data coefficient string via a loop when the last coefficient flag is ‘0’ and returning to the step of storing temporary variable data; and
setting ‘1’ to the last coefficient flag as the coefficient flag obtained in the loop is the last non-zero coefficient when the last coefficient flag is ‘1’.

17. A method for decoding a variable length code comprising:
initializing variables, data, coefficient flags, and the last coefficient flag to be internally used to ‘0’ and initializing the number of bits m to be used for determination of a pixel data coefficient string from the beginning of the pixel data coefficient string to ‘n’;
extracting m-bit data from the pixel data coefficient string and storing the m bit data in temporary variable data;
obtaining the number of outputtable coefficient flags from a reference table, the sum of the number of the outputtable coefficient flags and the number of a corresponding last coefficient flag, a flag that indicates whether the last coefficient flag is ‘1’, and the values of the outputtable coefficient flags using the temporary variable data as an index;
calculating coefficient flags, variable data necessary for a loop processing, and the number of bits m from the variables obtained from the reference table;
storing values of the same number of respective coefficient flags as the outputtable coefficient flags, and processing to-be-shifted bits of data corresponding to the sum of the number of the outputtable coefficient flags and the number of a corresponding last coefficient flag, so as to shift the data to-be-shifted bits to the left and holding lower n bits of the variable data;
determining whether the last coefficient flag is ‘1’;
extracting m-bit data from the pixel data coefficient string via a loop when the last coefficient flag is ‘0’ and returning to the step of storing the m bit data in temporary variable data; and
setting ‘1’ to the last coefficient flag as the coefficient flag obtained in the loop is the last non-zero coefficient when the last coefficient flag is ‘1’.

18. The method for decoding a variable length code of claim 16, wherein in the initializing, the number of bits for the determination is three bits.

19. The method for decoding a variable length code of claim 17, wherein in the initializing, the number of bits for the determination is four bits.

20. The method for decoding a variable length code of claim 17, wherein in the initializing, the number of bits for the determination is either four or three bits.
